(19) United States
(12) Patent Application Publication
(10) Pub. No.: US 2024/0337357 A1
(43) Pub. Date: Oct. 10, 2024

(54) LIGHT-EMITTING FLAT CABLE STRUCTURE

(71) Applicant: Huizhou Xunyuda Electronic Technology Co., Ltd., Huizhou (CN)

(72) Inventors: Yonghong LIAO, Huizhou (CN); Xinqiang ZHANG, Zigong (CN)

(73) Assignee: Huizhou Xunyuda Electronic Technology Co., Ltd., Huizhou (CN)

(21) Appl. No.: 18/304,791

(22) Filed: Apr. 21, 2023

(30) Foreign Application Priority Data
Sep. 30, 2022 (CN) 202222607464.1
Apr. 6, 2023 (CN) 202320741281.0

(51) Int. Cl. F21S 4/26; F21V 17/16; F21V 23/06

(52) U.S. Cl. CPC F21S 4/26; F21V 17/164; F21V 23/06; F21Y 2115/10

(57) ABSTRACT

The present application relates to the technical field of cables. Disclosed is a light-emitting flat cable structure with convenient assembly and high reliability, which includes a cable device and a light-emitting device. The cable device includes a flat cable and connectors at both ends thereof, and both ends of the light-emitting device are connected to the flat cable through fixing parts; the light-emitting device includes a light guide plate and a plurality of parallel arranged lamp strips, a plurality of light guide strips are arranged in the light guide plate, a plurality of light sources are arranged on each lamp strip, and each lamp strip penetrates through one light guide strip.

### CROSS-REFERENCE TO RELATED APPLICATIONS

The application claims priority to Chinese patent application No. 202320741281.0, filed on Apr. 6, 2023, the entire contents of which are incorporated herein by reference.

### FIELD OF TECHNOLOGY

The present application relates to the technical field of cables, in particular to a light-emitting flat cable structure.

### BACKGROUND

With the improvement of people's living standards, personal computers have entered thousands of households. A circuit of computer's motherboard and a circuit of peripheral equipment are mainly connected by computer flat cables, so that computer flat cable play a very important role in computers.

Light-emitting flat cables are common flat cables that can draw users' attention. However, the lamp beads in the existing light-emitting flat cables (refer to CN207753268U) are usually arranged on one side of the light guide strip, resulting in light being emitted from an end face of a light guide strip, and since one light guide strip corresponds to one lamp bead, and one light guide strip can only emit light of one color, the lighting effect of change is small, and the installed lamp panel shall be aligned with a center position of the end face of the light guide strip, so it is easy to affect the light guide effect if there is deviation and dislocation.

Therefore, it is necessary to improve the prior art and provide a light-emitting flat cable structure.

### SUMMARY

The technical problem to be solved by the present application is that aiming at the defects in the prior art that the installed lamp panel shall be aligned with the central position of the end face of the light guide strip, and the light guide effect is easily affected if the lamp panel is deviated and misplaced, the present application provides a light-emitting flat cable structure with convenient assembly and high reliability.

The technical solution adopted by the present application for solving the technical problem is that a light-emitting flat cable structure is constructed, which includes a cable device and a light-emitting device,

the cable device includes a flat cable and connectors at two ends of the flat cable, two ends of the light-emitting device are connected to the flat cable through a fixing part; and

the light-emitting device includes a light guide plate and a plurality of parallel arranged lamp strips, the guide light plate being provided with a plurality of light guide strips, each of the plurality of lamp strips being provided with a plurality of light sources, and each of the plurality of lamp strips being arranged in one light guide strip.

In some embodiments, the two ends of the light-emitting device are detachably connected to the flat cable through the fixing part.

In some embodiments, the fixing part includes:
an upper fastener including a first horizontal part, one end of the first horizontal part being provided with a vertical part, the first horizontal part being provided with a first limiting part at either side; and
a lower fastener including a second horizontal part, the second horizontal part being provided with a second limiting part at either side.

In some embodiments, the first limiting part is provided with a buckle on an inner side, and the vertical part is provided with a threading hole; and
the second horizontal part is provided with a slot fitting with the buckle.

In some embodiments, the first limiting part is provided with a notch at a lower end, and the second limiting part is provided with a protrusion at an upper end, the protrusion fitting with the notch.

In some embodiments, the first horizontal part is provided with a plurality of positioning columns at a lower end, and the light guide plate is provided with positioning holes, and the positioning columns penetrate through the positioning holes.

In some embodiments, the first limiting part on either side of the upper fastener is provided with an axially arranged tough body, and the first horizontal part is provided with an indent at either side,
a buckle body extending inward is arranged at a top of the second limiting part, and
when the upper fastener mates with the lower fastener, the second limiting part is embedded in the tough body on the first limiting part, and the buckle body is engaged in the indent.

In some embodiments, the second limiting part is movable relative to two ends of the second horizontal part along an axial direction of the second limiting part.

In some embodiments, the second limiting part is movable in an angle range of 90 degrees to 180 degrees relative to the second horizontal part.

In some embodiments, the second horizontal part is provided with a movable slot at an end where the second horizontal part is connected to the second limiting part for allowing the second limiting part to move.

In some embodiments, the indent forms an upward raising slope with an adjacent side of the tough body.

In some embodiments, the first limiting part is provided with a downward indenting positioning part at a bottom, and

the second horizontal part is provided with a limiting hole fitting with the positioning part.

In some embodiments, at least a part of the light guide strip on an outermost side of the light guide plate is exposed to a side surface of the light guide plate.

In some embodiments, the light guide plate is selected to be made of elastic material.

In some embodiments, the light-emitting device further includes a lamp strip connecting part for connecting one ends of the plurality of lamp strips, the lamp strip connecting part being connected with a lighting effect control power line.

In some embodiments, the light-emitting device further includes a lighting effect controller, the lighting effect controller being connected to another end of the lighting effect control power line.

In some embodiments, the light guide strip is a TPE light guide strip.

In some embodiments, the light source is an LED light bead.

With the light-emitting flat cable structure of the present application, which includes a cable device and a light-emitting device, it is possible to avoid the existing problem of easy deviation and dislocation caused by the end of one light guide strip corresponding to one light source by providing a plurality of light guide strips in the light guide plate, and arranging each lamp strip with a plurality of light sources inside one light guide strip to make the relative position of the lamp strip and the light guide strip stable.

On the other hand, both ends of the light-emitting device can be detachably connected to the flat cable, which is convenient for replacing or maintaining the light-emitting device.

### BRIEF DESCRIPTION OF THE DRAWINGS

The present application will be further explained below with reference to the accompanying drawings and embodiments, in which:

FIG. 1 is a stereoscopic structural schematic diagram of a light-emitting flat cable structure according to an embodiment of the present application;

FIG. 2 is a stereoscopic structural schematic diagram of the light-emitting flat cable structure according to another embodiment of the present application;

FIG. 3 is a structural schematic diagram of a cable device in the light-emitting flat cable structure according to the present application;

FIG. 4 is a structural schematic diagram of a light-emitting device in the light-emitting flat cable structure according to the present application;

FIG. 5 is a structural schematic diagram of a lamp strip in the light-emitting flat cable structure according to the present application;

FIG. 6 is a structural schematic diagram of a light guide plate in the light-emitting flat cable structure according to the present application;

FIG. 7 is a stereoscopic structural schematic diagram of an upper fastener and a lower fastener according to an embodiment of the present application;

FIG. 8 is a decomposed structural schematic diagram of the upper fastener and the lower fastener according to an embodiment of the present application;

FIG. 9 is a decomposed structural schematic diagram of the upper fastener and the lower fastener according to another embodiment of the present application:;

FIG. 10 is a structural schematic diagram of the upper fastener in the light-emitting flat cable structure according to an embodiment of the present application;

FIG. 11 is a structural schematic diagram of the upper fastener in the light-emitting flat cable structure according to another embodiment of the present application;

FIG. 12 is a structural schematic diagram of the lower fastener in the light-emitting flat cable structure according to an embodiment of the present application; and

FIG. 13 is a partial enlarged structural schematic diagram at part A in FIG. 9.

In the drawings: cable device 1: flat cable 11, connector 12;
fixing part 2: upper fastener 21, first horizontal part 211, vertical part 212, first limiting part 213, notch 214, buckle 215, threading hole 216, positioning column 217, tough body 218, indent 219, positioning part 220;
lower fastener 22, second horizontal part 221, second limiting part 222, slot 223, protrusion 224, buckle body 225, movable slot 226, limiting hole 227;
light-emitting device 3: light guide plate 31, light guide strip 311, positioning hole 312, lamp strip 32, light source 321, lamp strip connecting part 33, lighting effect control power line 34.

### DESCRIPTION OF THE EMBODIMENTS

For a clearer understanding of the technical features, objects, and effects of the present application, detailed embodiments of the present application will now be described in detail with reference to the accompanying drawings.

It should be noted that when an element is referred to as be “fixed” to another element, it can be directly on the another element or a centered element may also be present. When an element is considered to be “connected” to another element, it may be directly connected to the other element or may be accompanied by a centered element. On the contrary, when an element is referred to as be “directly on” another element, there is no centered element. The terms “vertical,” “horizontal,” “left,” “right,” “one side,” “another side,” “one end,” “another end,” and similar expressions used herein are for illustrative purposes only and are not intended to limit the specific orientation of components in the product or device.

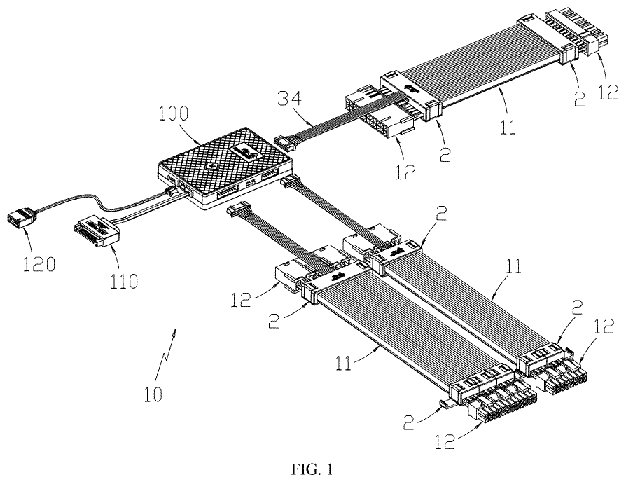

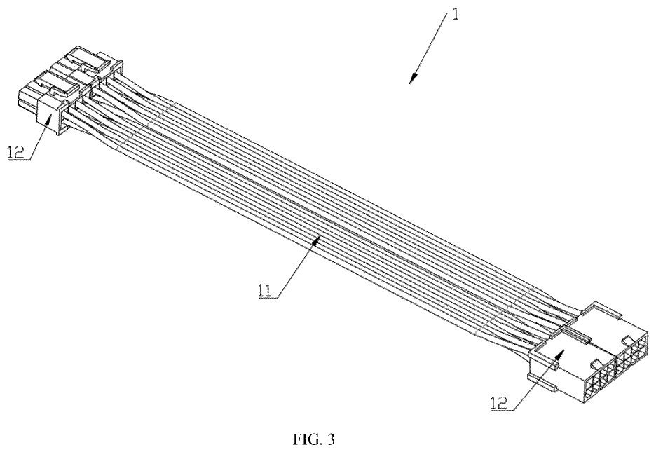

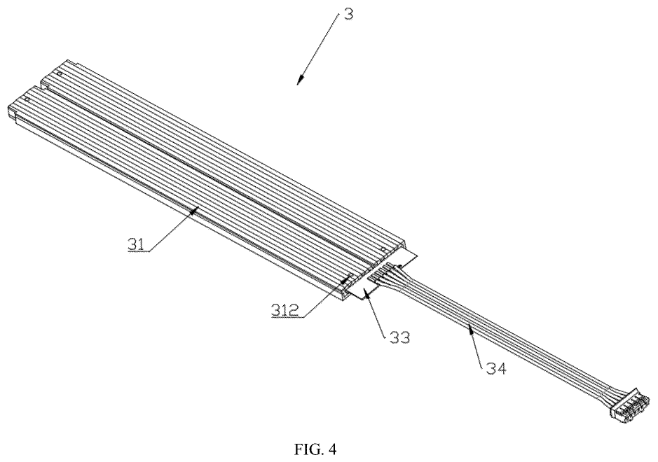

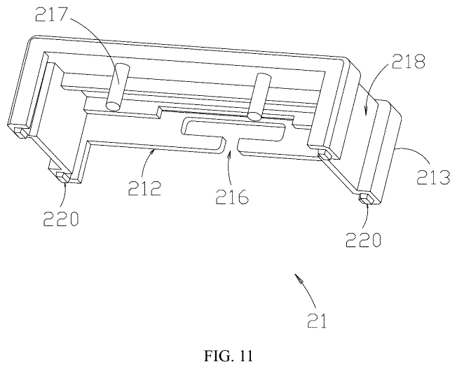

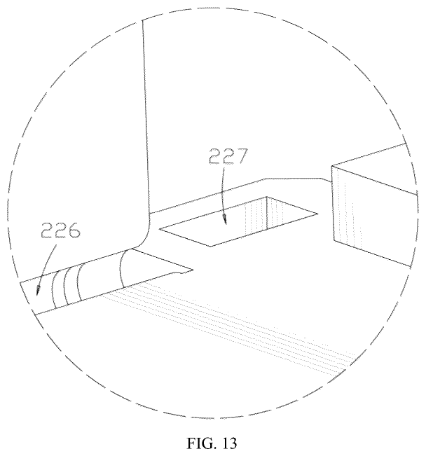

As shown in FIGS. 1-13, in the light-emitting flat cable structure according to a first embodiment of the present application, a light-emitting flat cable structure 10 includes a plurality of cable device 1, a plurality of fixing parts 2, and a light-emitting device 3.

The cable device 1 includes a flat cable 11 and connectors 12 at both ends thereof.

The fixing part 2 includes an upper fastener 21 and a lower fastener 22.

The light-emitting device 3 includes a light guide plate 31 and a plurality of lamp strips 32 arranged in parallel. Both ends of the light-emitting device 3 are connected to the flat cable 11 through the fixing parts 2.

The light guide plate 31 is provided with a plurality of light guide strips 311, each lamp strip 32 is provided with a plurality of light sources 321, and each lamp strip 32 penetrates through one light guide strip 311.

It should be noted that the light guide plate 31 may optionally be made of an elastic material such as a rubber strip or a silicone strip and is flexible as a whole.

Specifically, the flat cable 11 includes a plurality of cables arranged in parallel, the plurality of cables arranged in parallel may be a group of cables or be divided into a plurality of groups of cables (as shown in FIGS. 1-3), and the cables are divided into a plurality of groups so as to facilitate the connection of one ends of each group of cables to different electronic devices.

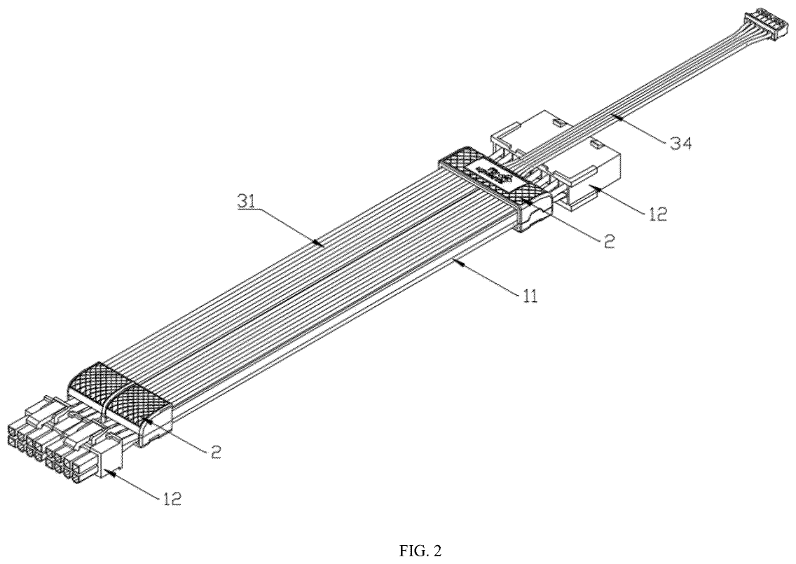

Further, the connector 12 is an existing common connector such as a 4pin connector 12, a 6pin connector 12, an 8pin connector 12 and a 24pin connector 12, but is not limited thereto. In addition, the light-emitting device 3 is located at one side of the flat cable 11 and parallel to the flat cable 11, the length direction of the light guide plate 31 is parallel to the length direction of the flat cable 11, the width of the light guide plate 31 matches the width of the flat cable 11, the light guide plate 31 may be one or more light guide plates 31 (as shown in FIG. 2), and the number of the light guide plates 31 corresponds to the number of groups of cables. Both ends of the light-emitting device 3 are connected to the flat cable 11 through the fixing parts 2, thereby facilitating the formation of lighting effect on one side of the flat cable 11.

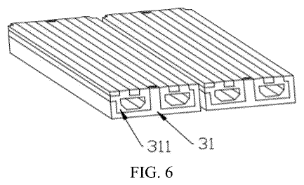

More specifically, as shown in FIG. 6, a plurality of light guide strips 311 are provided in the light guide plate 31 (two light guide strips are shown in each light guide plate in the figure), and it can be understood that other parts of the light guide plate 31 are made of a material that is unavailable for light guide and behaves elastically.

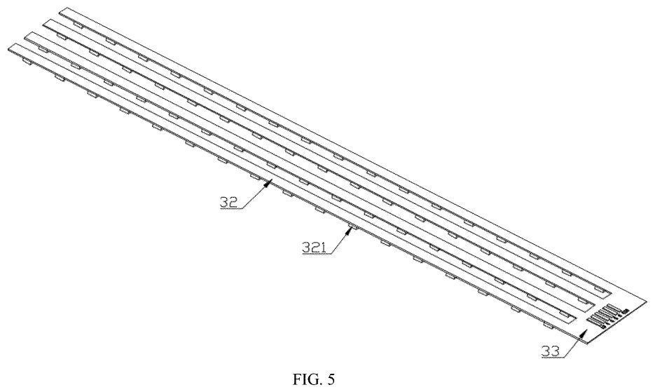

As shown in FIG. 5, the number of lamp strips 32 is at least two, and the number of lamp strips 32 shown in the figure is four: the length direction of the light guide strip 311 is parallel to the length direction of each lamp strip 32, each lamp strip 32 is provided with a plurality of light sources 321, and each lamp strip 32 penetrates through one of the light guide strips 311, so that when the lamp strip 32 emits light, light can be led out from the corresponding light guide strip 311.

As shown in FIG. 6, the light guide strip 311 is a TPE light guide strip 311, but is not limited thereto; TPE is a thermoplastic elastomer material with high resilience and good light conductivity. The light guide effect can be ensured and is easy bending by selecting the material of the light guide strip 311 as TPE.

As shown in FIG. 5, the light source 321 is an LED lamp bead, but is not limited thereto.

In addition, it can be understood that each light source 321 has its own signal line, each light source 321 or each lamp strip 32 can be controlled individually or as a whole, and a light effect mode control program can be written according to a customer's requirement to control the light-emitting effect of each light source 321 on the lamp strip 32, thereby producing various lighting effects.

The light-emitting flat cable structure 11 provided by the present application includes the cable device 1 and the light-emitting device 3, it is possible to avoid the existing problem of easy deviation and dislocation caused by the end of one light guide strip 311 corresponding to one light source 321 by providing a plurality of light guide strips 311 in the light guide plate 31, and arranging each lamp strip 32 with a plurality of light sources 321 inside one light guide strip 311 to make the relative position of the lamp strip 32 and the light guide strip 311 stable, and more lighting effects can be obtained through mode control.

Further, as shown in FIGS. 1 and 2, both ends of the light-emitting device 3 are detachably connected to the flat cable 11 through the fixing parts 2.

The light-emitting device 3 may be damaged during use or under other circumstances, and the cost can be reduced by replacing or repairing the light-emitting device, therefore the light-emitting device 3 and the flat cable 11 are arranged to be detachably connected. Specifically, both ends of the light-emitting device 3 are detachably connected to the flat cable 11 through the fixing parts 2, thereby facilitating detachment of the light-emitting device 3 from the flat cable 11 and facilitating replacement or maintenance of the light-emitting device 3.

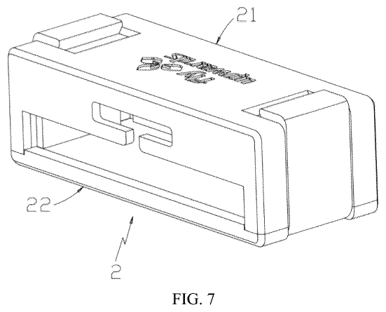

In some embodiments, as shown in FIGS. 7-9, the fixing part 2 includes an upper fastener 21 and a lower fastener 22, both of the upper fastener 21 and the lower fastener 22 are formed into inner hollow cuboid structures.

Further, the upper fastener 21 includes a first horizontal part 211, a vertical part 212 is provided at one end of the first horizontal part 211, and the first horizontal part 211 is provided with a first limiting part 213 at either side.

The lower fastener 22 includes a second horizontal part 221, and the second horizontal part 221 is provided with a second limiting part 222 at either side.

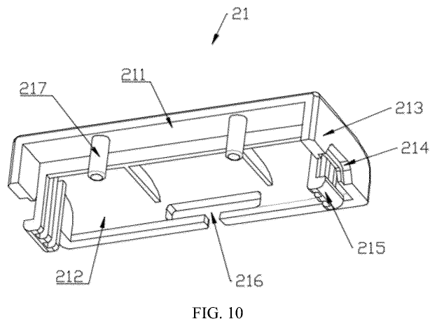

Further, as shown in FIG. 10, the first limiting part 213 is provided with a buckle 215 on an inner side, and the vertical part 212 is provided with a threading hole 216.

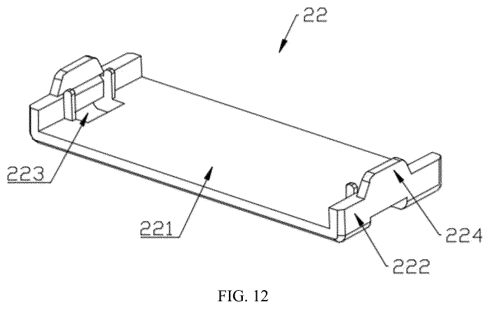

As shown in FIG. 12, the second horizontal part 221 is provided with a slot 223 fitting with the buckle 215. The slot 223 is provided on the inner corner side of the second horizontal part 221 adjacent to the second limiting part 222.

It can be understood that when the flat cable 11 is a group of cables, the width of the fixing part 2 matches the width of the flat cable 11. When the flat cable 11 includes a plurality of groups of cables, the width of the fixing part 2 matches the width of the flat cable 11, or the width of the fixing part 2 matches the width of one of the groups of cables.

In the case of fixation, the lower fastener 22 is arranged below the flat cable 11, the upper fastener 21 is arranged above the light-emitting device 3, the vertical part 212 is used for abutting one end of the light-emitting device 3, the first horizontal part 211 is used for abutting the upper side of the light-emitting device 3, the first limiting part 213 is used for limiting the light-emitting device 3 and the flat cable 11, the second limiting part 222 is used for limiting the fastener 215, and the threading hole 216 is used for allowing the wires led out from the lamp strip 32 to pass through. By adjusting the relative positions of the upper fastener 21, the lower fastener 22, the light-emitting device 3 and the flat cable 11, the upper fastener 21 and the lower fastener 22 are engaged and fixed through the buckle 215 and the slot 223 to press the light-emitting device 3 and the flat cable 11 and fix the two together.

Further, a notch 214 is provided at the lower end of the first limiting part 213, and a protrusion 224 fitting with the notch 214 is provided at the upper end of the second limiting part 222.

The arrangement of the notch 214 and the protrusion 224 facilitates the alignment of the upper fastener 21 and the lower fastener 22 during the engagement. When the upper fastener 21 and the lower fastener 22 are engaged and fixed, the notch 214 and the protrusion 224 come into contact with each other.

Further, the first horizontal part 211 is provided with a plurality of positioning columns 217 at a lower end, and the light guide plate 31 is provided with positioning holes 312, the positioning columns 217 penetrate through the positioning holes 312.

Since the light-emitting device 3 is made of a soft material, it is difficult to position the end of the light-emitting device at a time of fixing the light-emitting device 3 and the flat cable 11.

In addition, if positioning is achieved only by pressing the end of the light-emitting device 3, it is easy for the light-emitting device 3 to slide out of the fixing part 2 during use. Therefore, a plurality of positioning columns 217 are provided at the lower end of the first horizontal part 211, and positioning holes 312 are provided in the light guide plate 31, the positioning posts 217 penetrate through the positioning holes 312, thereby achieving a better fixing effect. In addition, the number of positioning columns 217 may be set according to the width of the light guide plate 31. It can be understood that the lower end of the positioning column 217 is higher than or flush with the lower end face of the light guide plate 31, which can prevent the positioning column 217 from causing damage to the flat cable 11.

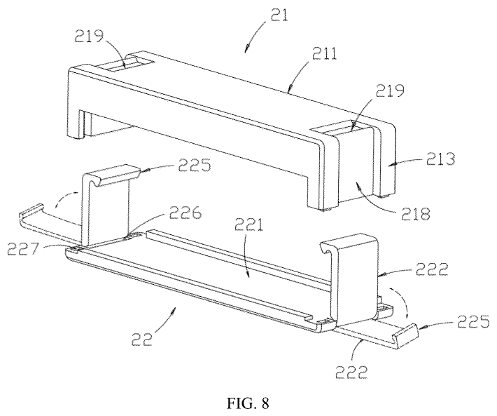

In some embodiments, as shown in FIG. 8, the first limiting part 213 on either side of the upper fastener 21 is provided with an axially arranged tough body 218, the left and right sides of the top of the first horizontal part 211 are provided with indents 219, and the top of the second limiting part 222 is provided with an inward extending buckle body 225.

When the upper fastener 21 is engaged with the lower fastener 22, the main body of the second limiting part 222 is fitted into the tough body 218 of the first limiting part 213, and the buckle body 225 is fitted into the indent 219, thereby fixing the second limiting part 222.

The indent 219 forms an upward raising slope with an adjacent side of the tough body 218, and the end of the buckle body 225 abuts against the raising slope, thereby fixing the buckle body 225.

Further, as shown in FIG. 8, the second limiting part 222 is movable relative to both ends of the second horizontal part 221 along its axial direction. The second limiting part 222 is movable in an angle range of 90 degrees to 180 degrees relative to the second horizontal part 221.

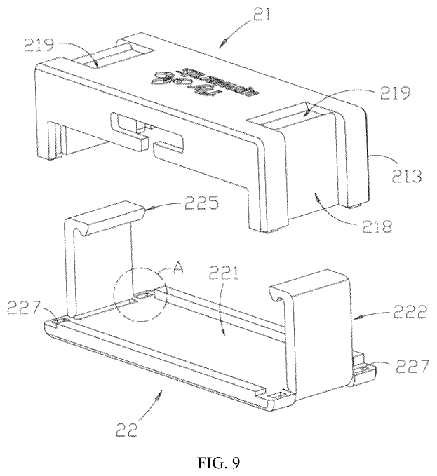

In some embodiments, as shown in FIGS. 8 and 9, the second horizontal part 221 is provided with a movable slot 226 at an end where the second horizontal part is connected to the second limiting part 222 for allowing the second limiting part 222 to move.

That is, when it is necessary to separate the upper fastener 21 from the lower fastener 22, an external force is applied to the second limiting part 222, and the buckle body 225 is separated from the indent 219, so that the upper fastener 21 and the lower fastener 22 are in a state of being separated from each other.

In the technical solution of the present application, the upper fastener 21 and the lower fastener 22 are made of polypropylene (PP), which has good stress cracking resistance and bending fatigue life. The upper fastener 21 and the lower fastener 22 are engaged from the periphery for easy disassembly and removal, thereby improving the quality and safety of products, reducing the difficulty of production and manufacturing, reducing the labor cost of assembly and improving the production efficiency.

In some embodiments, as shown in FIGS. 8 and 9, the first limiting part 213 is provided with a downward indenting positioning part 220 at a bottom, and the second horizontal part 221 is provided with a limiting hole 227.

Specifically, when the upper fastener 21 is engaged with the lower fastener 22, the positioning part 220 of the first limiting part 213 is fitted into the limiting hole 227 of the second horizontal part 221, thereby improving the accuracy and assembly efficiency when the upper fastener 21 is engaged with the lower fastener 22.

Further, the light guide strip 311 on an outermost side of the light guide plate 31 is at least partially exposed to a side surface of the light guide plate 31.

If the light guide strip 311 is only exposed to the surface of the light guide plate 31, the light guide strip 311 can only conduct light to the surface of the light guide plate 31, but cannot conduct light to the side surface of the light guide plate 31, which affects the lighting effect; therefore, the light guide strip 311 located on the outermost side of the light guide plate 31 is at least partially exposed to the side surface of the light guide plate 31 (such as the light guide strip on the left side in FIG. 6), so that light is conducted to the side surface of the light guide plate 31, and light guide effects are formed in at least two directions of the flat cable 11.

Further, the light-emitting device 3 further includes a lamp strip connecting part 33 for connecting one ends of the plurality of lamp strips 32, the lamp strip connecting part 33 is connected with a lighting effect control power line 34.

The lamp strip connecting part 33 is used for connecting one ends of a plurality of lamp strips 32 and supplying power to the lamp strip 32 through the lighting effect control power line 34 to cause the lamp strip to emit light. The lamp strip connecting part 33 is also provided in the fixing part 2, and when the threading hole 216 is provided in the fixing part 2, the lighting effect control power line 34 can penetrate through the threading hole 216.

Further, the light-emitting device 3 further includes a lighting effect controller 100 which is connected to another end of the lighting effect control power line 34.

The lighting effect controller is used for connecting the lamp strip 32 through the lighting effect control power line 34 to control the light-emitting effect of the lamp strip 32.

When in use, after the light-emitting flat cable 11 in structure of the cable device 1 of the present application is mounted to a computer motherboard and connected to an electronic device, the light effect controller controls the light source 321 on the lamp strip 32 to emit light, and the light is led out through the light guide strip 311, so that the structure of the light-emitting flat cable 11 enters a light-emitting state and an attractive light color change is generated.

The light-emitting flat cable structure 11 provided by the present application includes the cable device 1 and the light-emitting device 3, it is possible to avoid the existing problem of easy deviation and dislocation caused by the end of one light guide strip 311 corresponding to one light source 321 by providing a plurality of light guide strips 311 in the light guide plate 31, and arranging each lamp strip 32 with a plurality of light sources 321 inside one light guide strip 311 to make the relative position of the lamp strip 32 and the light guide strip 311 stable. In addition, both ends of the light-emitting device 3 can be detachably connected to the flat cable 11, which is convenient for replacing or maintaining the light-emitting device 3.

Embodiments of the present application are described above in conjunction with the accompanying drawings. However, the present application is not limited to the detailed embodiments described above, the embodiments described above is merely illustrative and not limiting, and those of ordinary skilled in the art may take many forms with reference to the present application without departing from the scope of the object and claims of the present application, all of which fall within the protection of the present application.

What is claimed is:

1. A light-emitting flat cable structure comprising a cable device and a light-emitting device,
wherein the cable device comprises a flat cable and connectors at two ends of the flat cable, two ends of the light-emitting device are connected to the flat cable through a fixing part; and
the light-emitting device comprises a light guide plate and a plurality of parallel arranged lamp strips, the guide light plate being provided with a plurality of light guide strips, each of the plurality of lamp strips being provided with a plurality of light sources, and each of the plurality of lamp strips being arranged in one light guide strip.

2. The light-emitting flat cable structure according to claim 1, wherein
the two ends of the light-emitting device are detachably connected to the flat cable through the fixing part.

3. The light-emitting flat cable structure according to claim 1, wherein
the fixing part comprises:
an upper fastener comprising a first horizontal part, one end of the first horizontal part being provided with a vertical part, the first horizontal part being provided with a first limiting part at either side; and
a lower fastener comprising a second horizontal part, the second horizontal part being provided with a second limiting part at either side.

4. The light-emitting flat cable structure according to claim 3, wherein
the first limiting part is provided with a buckle on an inner side, and the vertical part is provided with a threading hole; and
the second horizontal part is provided with a slot fitting with the buckle.

5. The light-emitting flat cable structure according to claim 4, wherein
the first limiting part is provided with a notch at a lower end, and the second limiting part is provided with a protrusion at an upper end, the protrusion fitting with the notch.

6. The light-emitting flat cable structure according to claim 4, wherein
the first horizontal part is provided with a plurality of positioning columns at a lower end, and the light guide plate is provided with positioning holes, and the positioning columns penetrate through the positioning holes.

7. The light-emitting flat cable structure according to claim 3, wherein
the first limiting part on either side of the upper fastener is provided with an axially arranged tough body, and the first horizontal part is provided with an indent at either side,
a buckle body extending inward is arranged at a top of the second limiting part, and
when the upper fastener mates with the lower fastener, the second limiting part is embedded in the tough body on the first limiting part, and the buckle body is engaged in the indent.

8. The light-emitting flat cable structure according to claim 7, wherein
the second limiting part is movable relative to two ends of the second horizontal part along an axial direction of the second limiting part.

9. The light-emitting flat cable structure according to claim 8, wherein
the second limiting part is movable in an angle range of 90 degrees to 180 degrees relative to the second horizontal part.

10. The light-emitting flat cable structure according to claim 8, wherein
the second horizontal part is provided with a movable slot at an end where the second horizontal part is connected to the second limiting part for allowing the second limiting part to move.

11. The light-emitting flat cable structure according to claim 7, wherein
the indent forms an upward raising slope with an adjacent side of the tough body.

12. The light-emitting flat cable structure according to claim 7, wherein
the first limiting part is provided with a downward indenting positioning part at a bottom, and
the second horizontal part is provided with a limiting hole fitting with the positioning part.

13. The light-emitting flat cable structure according to claim 1, wherein
at least a part of the light guide strip on an outermost side of the light guide plate is exposed to a side surface of the light guide plate.

14. The light-emitting flat cable structure according to claim 13, wherein
the light guide plate is selected to be made of elastic material.

15. The light-emitting flat cable structure according to claim 1, wherein
the light-emitting device further comprises a lamp strip connecting part for connecting one ends of the plurality of lamp strips, the lamp strip connecting part being connected with a lighting effect control power line.

16. The light-emitting flat cable structure according to claim 15, wherein
the light-emitting device further comprises a lighting effect controller, the lighting effect controller being connected to another end of the lighting effect control power line.

17. The light-emitting flat cable structure according to claim 1, wherein
the light guide strip is a TPE light guide strip.

18. The light-emitting flat cable structure according to claim 1, wherein the light source is an LED lamp bead.
